(19) United States
(12) Patent Application Publication
(10) Pub. No.: US 2018/0346368 A1
(43) Pub. Date: Dec. 6, 2018

(54) METHOD OF MANUFACTURING GLASS VESSEL, AND APPARATUS FOR MANUFACTURING GLASS VESSEL

(71) Applicant: NIPRO CORPORATION, Osaka (JP)

(72) Inventor: Dave LISMAN, Millville, NJ (US)

(21) Appl. No.: 15/992,680

(22) Filed: May 30, 2018

Related U.S. Application Data
(60) Provisional application No. 62/512,878, filed on May 31, 2017.

(51) Int. Cl. C03B 29/02; C03C 23/00; C03B 21/06

(52) U.S. Cl. CPC C03B 29/02; C03C 23/007; C03C 4/20; C03B 2201/10; C03B 21/06

(57) ABSTRACT

A method of producing a glass vessel includes holding a borosilicate glass tube with a first holding device, and holding an open end portion of the glass tube with a second holding device such that the second holding device is spaced apart from the first holding device. Heat is applied to the glass tube by a burner to separate the open end portion and form a bottom portion on the open end portion. Fire-blast treatment of an inner surface of the open end portion with a flame from a point burner is performed during at least a part of (i) applying heat to the borosilicate glass tube for separation, (ii) applying heat to the separated open end portion for bottom portion formation, and/or (iii) a period applying heat to the separated open end portion and prior to releasing the glass vessel from the second holding device.

### BACKGROUND OF THE INVENTION

The present invention relates to a method of producing a glass vessel, in particular a glass vessel having a bottom, and especially a glass vessel for medical use such as a vial or an ampule.

A glass vessel, for example a glass vessel for medical use, is made of a borosilicate glass tube which has an excellent chemical resistance. By heating and forming a borosilicate glass tube, a mouth portion and a bottom portion of a vessel are formed. When the borosilicate glass tube is heated so as to form the glass vessel, alkali components contained in the glass tube are volatilized, and then condense and attach onto an inner surface of the vessel. A region where the alkali components (alkali condensate) attach to the inner surface becomes a deteriorated region caused by processing. The alkali components of the deteriorated region are then undesirably eluted into a medicine or other material stored within the vessel, so that the stored material is adversely affected. ISO 4802-1 and 2 (Glassware: Hydrolytic resistance of the interior surface of glass containers) prescribe standards for an elution amount of alkali components from an inner surface of a glass vessel. In addition to the problem of elution of the alkali components into the stored material, silica particles or flakes peel off from an inner surface of the vessel and become mixed with the material within the vessel.

It is known to suppress alkali elution from an inner surface of a glass vessel. For example, U.S. Pat. No. 8,522,575 teaches formation of a glass vessel from a borosilicate glass tube. As the glass vessel is formed, alkali components are volatilized and adhere to the inner surface of the glass vessel, and so the accumulated alkali components (alkali condensate) on the inner surface of the glass vessel will exceed the standards set forth in ISO 4802. Therefore, as shown in FIG. 1, after formation of the glass vessel 1 with the bottom surface 2, an inner surface of the glass vessel 1 is fire-blast treated with an oxygen-gas flame 3 from a point burner 4 having a nozzle 5 extending inside the glass vessel 1. As a result, the deteriorated region with the alkali condensate caused by processing is at least partially removed, and alkali elution is reduced, and also the potential of peeling off silica is significantly reduced.

However, performing the fire-blast treatment as an intermediate step after formation of the glass vessel and prior to a subsequent annealing step has drawbacks. In particular, the intermediate fire-blast step requires that the formed glass vessels first be transported to an intermediate location for performance of the fire-blast treatment before then being transported to a subsequent processing station, such as an oven for the annealing process. Consequently, the overall glass vessel production time is increased, and production efficiency can be decreased.

Alternatively, U.S. Pat. No. 9,409,808 teaches air evacuation by injecting a pressurized gas (air) through a supply tube and into the mouth of the glass vessel, and the pressurized gas is then discharged out through the mouth of the vessel. As a result, adhesion of alkali components to the inner surface of the glass vessel is slightly reduced, and so alkali elution is minimized.

However, air evacuation through the introduction of pressurized gas into the glass vessel also suffers from drawbacks. While application of such pressurized gas does somewhat limit the formation of alkali condensate on the inside of the vial, this process does not remove alkali condensate and restore the inner surface to a base glass matrix. Applying enough pressurized gas to significantly reduce formation of alkali condensate on the inner surface of the glass vessel would result in distortion of the glass vessel during the formation steps when the glass is above the melting and working temperature and more prone to being deformed. Moreover, applying the relatively cool pressurized gas (air) to the inner surface of the glass vessel during formation of the glass vessel will cool the inner surface and allow volatilized alkali components to condense, thereby reducing much of the benefit of applying the pressurized gas with respect to reduction of alkali elution.

### SUMMARY OF THE INVENTION

The present invention has been developed in order to address the above-noted drawbacks. In particular, the present invention includes a method of producing a glass vessel and an apparatus for producing a glass vessel, in which the glass vessel can be produced more efficiently and with a significant and preferably nearly complete reduction in alkali elution. More particularly, the method includes holding a borosilicate glass tube with a first holding device; and holding an open end portion of the borosilicate glass tube with a second holding device such that the second holding device is spaced apart from the first holding device along a direction which corresponds to an axis of the glass tube. The method further includes applying heat to the borosilicate glass tube by a burner at a location between the first holding device and the second holding device so as to soften the borosilicate glass tube and separate the open end portion from a remainder of the borosilicate glass tube, and applying heat to the separated open end portion to form a bottom portion on the open end portion and thereby form the glass vessel. Upon or some time after completion of the application of heat to the separated open end portion to form the glass vessel, the glass vessel is released from the second holding device so as to transport the glass vessel to a subsequent processing station.

An inner surface of the open end portion is fire-blast treated with a flame from a point burner during at least a part of at least one of (i) the application of heat to the borosilicate glass tube, (ii) the application of heat to the separated open end portion to form the bottom portion, and (iii) a period after the application of heat to the separated open end portion and prior to the release of the glass vessel from the second holding device.

As a result of the present method, alkali components can be removed from the interior of the glass vessel so as to prevent elution of the alkali components into material within the vessel. Furthermore, because the fire-blast treatment is performed during the application of heat to the borosilicate glass tube the application of heat to the separated open end portion, and/or after the application of heat to the separated open end portion and prior to the release of the glass vessel from the second holding device, the overall manufacturing process is performed more efficiently and preferably quicker.

It has been found that fire-blast treatment to remove a deteriorated region with alkali components caused by processing and to thereby reduce an amount of alkali elution from an inner surface of the glass vessel is most efficient if a temperature of an external surface of a preform (i.e., the separated end portion to be formed into the glass vessel) is between 650° C. and 800° C. Therefore, the method of producing the glass vessel further includes performing the fire-blast treatment such that a temperature of an outer surface of the open end portion opposite to a deteriorated region on the inner surface of the open end portion is between 650° C. and 800° C. The temperature can be measured using a non-contact thermometer.

The fire-blast treatment can include jetting an oxygen-flammable gas flame containing an oxonium ion toward the inner surface of the open end portion, and the oxygen-flammable gas flame containing the oxonium ion can be a mixed gas flame of a flammable gas (such as a city gas, a low hydrocarbon (e.g. methane, ethane, propane) or the like) and oxygen. Furthermore, the glass vessel can be a glass vial ampule for medical use.

In addition, gas evacuation of the glass vessel prior to or after the fire-blast treatment can be performed. Furthermore, the subsequent processing station can be an oven, and the glass vessel can be annealed in the oven after the glass vessel is released from the second holding device. Although not particularly limited, the first holding device can be a first chuck, and the second holding device can be a second chuck. It is also possible to use holding devices such as rollers.

The present invention also includes an apparatus for producing a glass vessel. In particular, the apparatus includes a first holding device configured to hold a borosilicate glass tube; and a second holding device configured to hold an open end portion of the borosilicate glass tube, in which the second holding device is spaced apart from the first holding device along a direction of the glass tube. A burner is configured to apply heat to the borosilicate glass tube at a location between the first holding device and the second holding device so as to soften the borosilicate glass tube and separate the open end portion from a remainder of the borosilicate glass tube, and the other burner is configured to apply heat to the separated open end portion to form a bottom portion on the open end portion and thereby form the glass vessel.

The apparatus also includes a point burner configured to perform fire-blast treatment of an inner surface of the open end portion with a flame while the second holding device holds the open end portion and during at least a part of at least one of (i) application of heat to the borosilicate glass tube by the burner (ii) application of heat to the separated open end portion to form the glass vessel, and (iii) a period after the application of heat to the separated open end portion and prior to release of the glass vessel by said second holding device.

The point burner can be configured to perform the fire-blast treatment such that a temperature of an outer surface of the open end portion opposite a deteriorated region of the open end portion is between 650° C. and 800° C. A non-contact thermometer can be used to measure the temperature.

The point burner is configured to jet an oxygen-flammable gas flame containing an oxonium ion toward the inner surface of the open end portion, and the oxygen-flammable gas flame containing the oxonium ion can be a mixed gas flame of a flammable gas and oxygen. Furthermore, the glass vessel can be a glass vial for medical use.

A gas evacuation device can be provided for performing gas evacuation of the glass vessel prior to or after the fire-blast treating. In addition, an oven can be provided to anneal the glass vessel after the glass vessel is released from the second holding device. Although not limited, the first holding device can be a first chuck, and the second holding device is a second chuck. Other types of holding devices such as rollers can also be used.

In the present description, the term “glass vessel” means a glass vessel having a bottom and in a condition before, during, or after the fire-blast treatment by the point burner.

The glass vessel is formed of a borosilicate glass tube using, for example, a formation process in which the glass tube is held vertically and heated using a vertical forming machine so as to be softened. The glass vessel has a closed bottom portion at a first (e.g., upper) end while having an open mouth portion at a second (e.g., lower) end. The glass vessel can have a circular cylindrical shape (i.e. a form in which a cross section perpendicular to the longitudinal axis thereof is a circle), but it is not limited to such a circular cylindrical shape. It may be any other form as required, such as a rectangular cylinder or a triangle cylinder, and it may be formed such that a length along its central axis is smaller than its diameter (for example, a low circular cylinder form). The glass vessel may be in the form of a vial, an ampule, or a similar container, and its cross section perpendicular to its longitudinal axis may change along its axis. For example, it may have a constricted (narrow) portion.

By fire-blast treatment in the manner set forth herein, an amount of the alkali elution from the produced glass vessel is suppressed and silica particles are removed, and production rate and efficiency are improved. It is not necessarily required that the fire-blast treatment be applied to an entirety of the inner surface of the open end portion being formed into the glass vessel. Furthermore, the fire-blast treatment can be applied to the bottom portion of the glass vessel (after formation of the bottom portion).

Further advantages are offered by the manner described herein, specifically related to the elimination of additional transfer and handling steps in order to fire-blast glass vessels in a step after forming and release from the rotating chuck. These additional transfer points can lead to losses negatively impacting production rates. Another advantage is offered from the elimination of having a secondary process that requires additional alignment steps during setup leading to an increase in downtime of the equipment.

### BRIEF DESCRIPTION OF THE DRAWINGS

FIG. 1 is a schematic diagram illustrating a conventional fire blast treatment process.

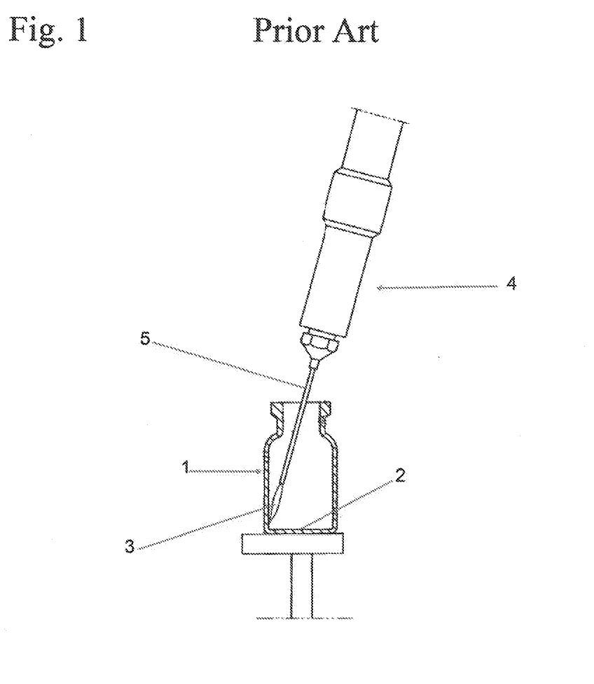

FIG. 2 is a plan view of a vertical glass vessel producing apparatus which is schematically shown for ease of understanding.

FIG. 3 is a partial elevation view of the vertical glass vessel producing apparatus of FIG. 2.

FIG. 4 is a schematic diagram illustrating the fire-blast treatment process of the present invention.

### DETAILED DESCRIPTION OF THE INVENTION

The present invention will hereinafter be explained in detail by describing an embodiment of a method of producing a glass vessel, and an embodiment of an apparatus for producing the glass vessel. However, it is to be understood that the specific features explained below are simply exemplary, and it should be clear to a person of ordinary skill in the art that the method and apparatus can be modified within the scope of the claims.

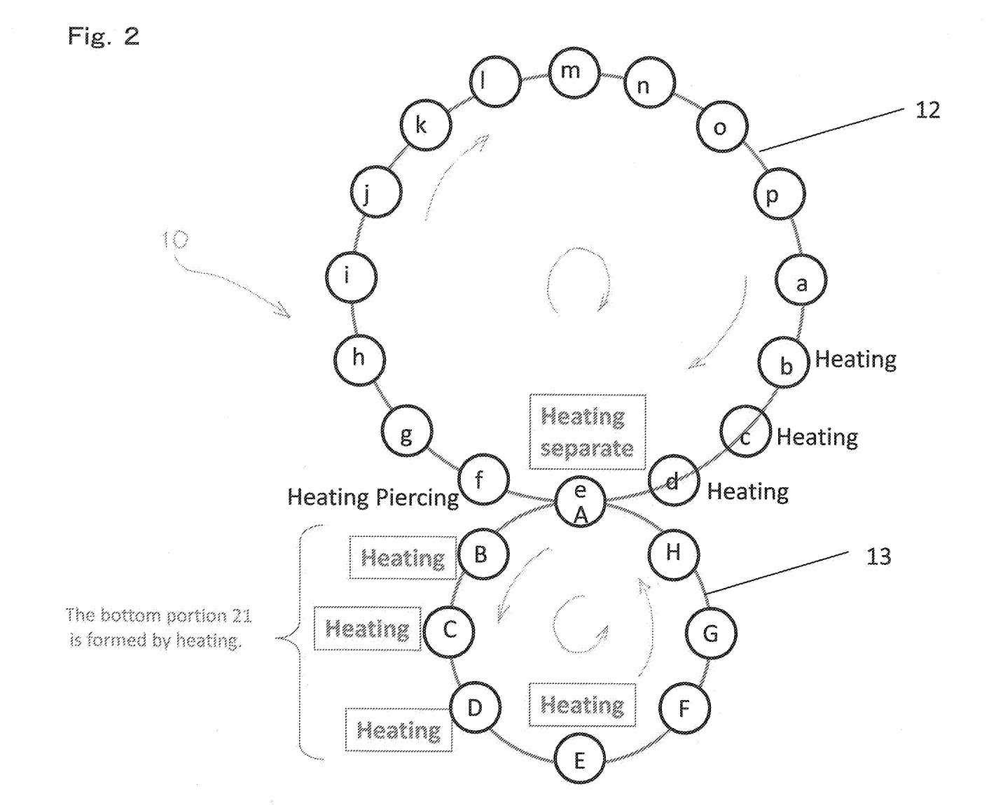

FIG. 2 illustrates an apparatus 10 for producing a glass vessel 11 (not shown in FIG. 2), and the apparatus 10 is of the vertical glass forming variety. The apparatus 10 includes a pair of turntables 12, 13, with the first (upper) turntable 12 including a plurality of first (upper) holding devices 14, and the second (lower) turntable 13 including a plurality of second (lower) holding devices 15. Each of the second holding devices 15 is associated with a point burner 16 for performing the fire-blast treatment during formation of the glass vessel 11.

In the apparatus 10 shown in FIG. 2, the turntables rotate synchronously and intermittently at a predetermined interval with the turntable 12 rotating clockwise while the turntable 13 rotates counterclockwise, such that one first holding device (the device located at the position “e” in the embodiment of FIG. 2) is located just above a second holding device (the device located at the position “A” in the embodiment shown in FIG. 2) at a certain timing as shown in FIG. 2. Thus, both devices hold a glass tube (not shown in FIG. 2) together at such timing. In the embodiment shown in FIG. 2, the turntable 12 rotates by increments of 22.5 degrees intermittently (because the sixteen holding devices of turntable 12 are evenly spaced apart) while the turn table 13 rotates by increments of 45 degrees intermittently (because the eight holding devices of turntable 13 are evenly spaced apart). The term “intermittently” means that the table repeats turning by the above mentioned increments and then stopping for a period of time for a predetermined action depending on the position, such as actions including the application of heat, the separation from the glass tube, cooling, the bottom formation and/or releasing from the turn table.

In the embodiment shown in FIG. 2, it is readily seen at the next timing that the first holding device located at the position “d” which is already holding the next glass tube will be positioned after 22.5 degree rotation so that it will be located just above the second holding device after 45 degree rotation which is located at the position “H”, which second holding device will also hold the next glass tube so that those holding devices will hold the next glass tube together.

The fire-blast treatment is carried out during at least a part of the term when the second holding device holds a glass tube, a preform for the glass vessel, and a glass vessel after the formation of the bottom portion during any period after the turn table has just stopped and just before the turn table will start to turn again.

When focusing on a certain second holding device, the fire-blast treatment is carried out during at least a part of a period when said second holding device turns by almost 360 degrees from the position “A” through the position “E” toward the position “A” before the glass vessel is released from the second holding device. That is, the fire-blast treatment may be carried out throughout such period at any one, or any combination of two or more of the positions “A” to “H”.

In one embodiment, the fire-blast treatment is carried out when the second holding device is tentatively stopped at only the position “A” or at the positions from the position “A” to the position “C”. In another embodiment, the fire-blast treatment is carried out when the second holding device is tentatively stopped at only the position “D” or at the positions from the position “D” to the position “G”.

In a further embodiment, the fire-blast treatment is carried out when the second holding device moves from the position “E” to the position “H”. In a further embodiment, the fire-blast treatment is carried out when the second holding device moves from the position “F” to the position “G” or the position “H”. It is, of course, possible that the fire-blasting is carried out only when the second holding device is located at any one, two, or more positions of “A” to “H”, for example, only at the position “F”, or at the positions of “F” and “G”.

The point burner which carries out the fire-blast treatment is correlated with the second holding device and is located such that the fire-blast treatment can be carried out when the turntable 13 is intermittently stopped, and the point burner may be (but does not need to be) located at each position where the second holding device intermittently stops. In one embodiment, it may be located at limited position (s), for example, one, any combination of two, or more positions “E”, “F”, “G” and “H”.

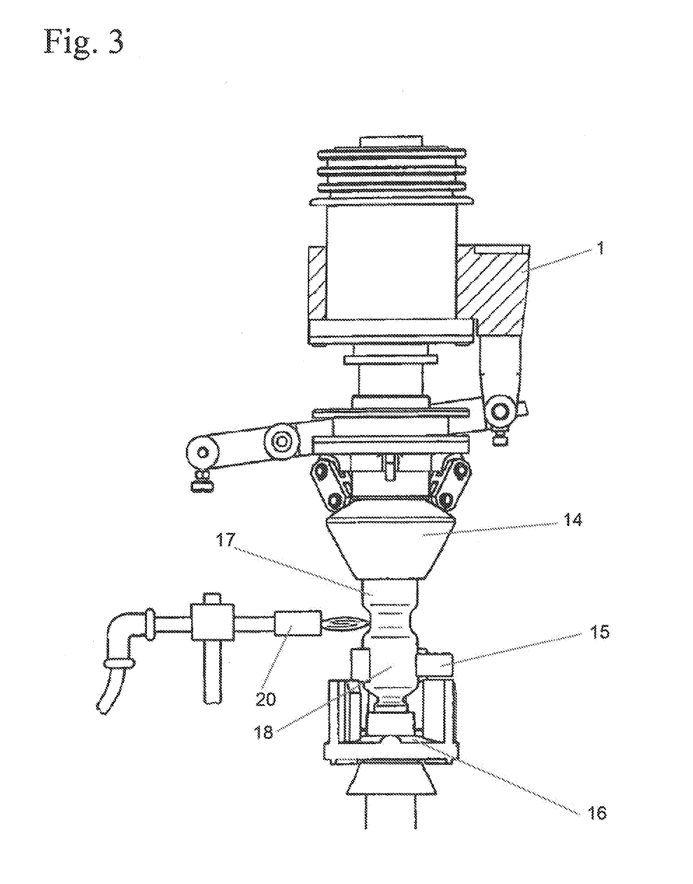

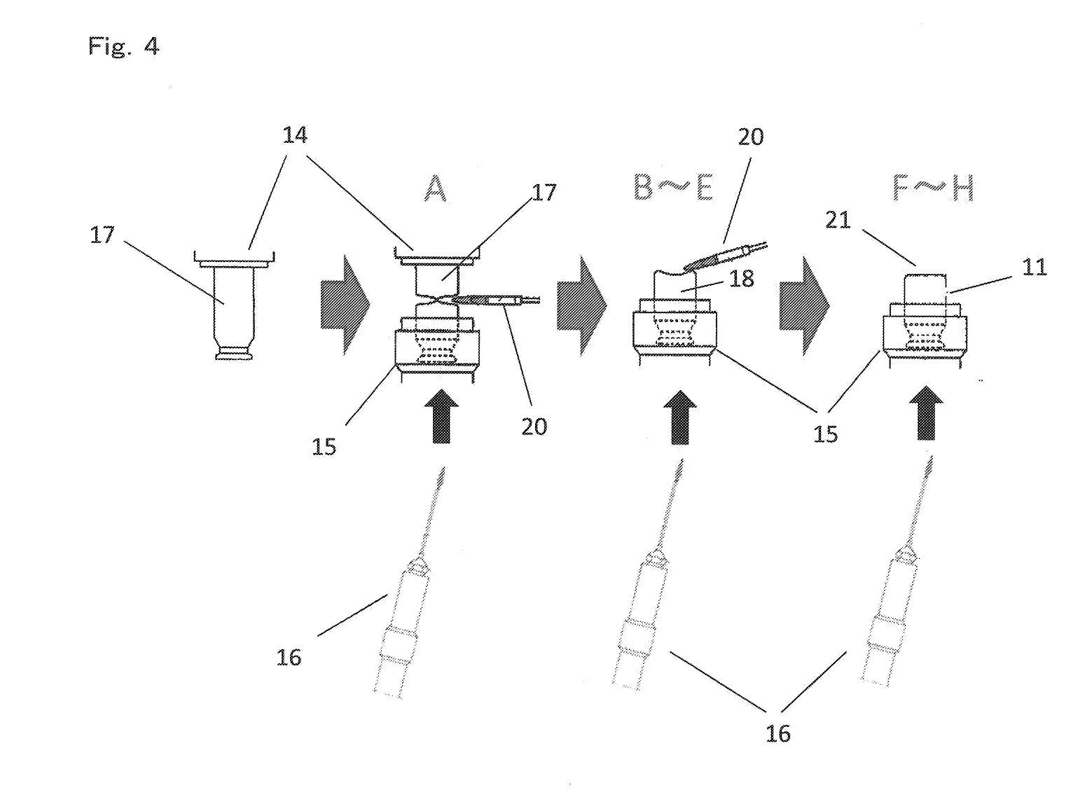

As shown in FIG. 3, the first holding device 14 holds a borosilicate glass tube 17 during the glass vessel formation process. While the first holding device 14 holds the glass tube 17 and the second holding device 15 holds a lower open end portion 18 of the glass tube 17 at the positions “A” and “e” as shown in FIG. 2, a burner 20 applies heat at a location between the holding devices 14 and 15 to soften the glass tube 17 and eventually separate the open end portion 18 from a remainder of the glass tube 17 (see the state at the position “A” in FIG. 4). As the burner 20 continues to apply heat to the upper edge of the separated open end portion 18, a bottom portion 21 is formed on the open end portion 18 (see the state at the positions “B” to “E” in FIG. 4) so as to form the glass vessel 11. In this regard, please note that FIGS. 3 & 4 illustrate the glass vessel 11 being formed upside-down so that the opening is towards the bottom and the bottom portion 21 is at the top. It may, of course, be possible to reverse this arrangement as necessary. FIG. 4 also shows the state at the positions “F” to “H” wherein no heat is applied by the burner 20 so that the glass vessel 11 may be cooled.

In the apparatus 10 shown in FIGS. 2-4, the first and second holding devices 14 and 15 are holding chucks. However, it is also possible for one or more of the holding devices 14, 16 to be comprised of a different component, such as rollers.

As noted above and shown in FIGS. 3 and 4, a point burner 16 is associated with the second (lower) holding device 15. As the burner 20 applies heat to the glass tube 17 and open end portion 18 for separating the open end portion 18 from the remainder of the glass tube 17 and for subsequently forming the bottom portion 21 on the open end portion 18 to form the glass vessel 11, the second holding device 15 holds the open end portion 18, as explained above. During at least a part of this same time period, the point burner 16 applies a flame to the inside of the open end portion 18 and/or glass vessel 11. The point burner 18 is oriented in such a way as to apply the flame to a region of an inside surface of the open end portion 18 and/or glass vessel 11 where alkali components are being volatilized due to the heat of formation applied by burner 20. Thus, the alkali components (alkali condensate) can be removed before or immediately after being attached to the inside surface so as to prevent formation of a deteriorated region during production of the glass vessel 11.

There is no particular manner in which the point burner 16 is to be associated with the second holding device 15. This arrangement simply requires that the point burner 16 be configured to apply the flame to the inner surface of the open end portion 18 (glass vessel 11) while the second holding device 15 holds the open end portion 18 (glass vessel 11). Thus, the point burner 16 can be directly or indirectly attached to the second holding device 15, or can be unattached to the second holding device 15 but nonetheless supported, oriented, and arranged in such a way as to apply the flame to the inner surface of the open end portion 18 (glass vessel 11) while the second holding device 15 holds the open end portion 18 (glass vessel 11).

The process described above is illustrated in the schematic diagram of FIG. 4, which shows the sequence of steps for forming the glass vessel, as described above. In the initial step shown in the image farthest to the left, the first holding device 14 holds the borosilicate glass tube 17. As indicated by the large horizontal arrows, the process proceeds to the next steps shown to the right. Firstly, the second holding device 15 holds the open end portion 18 of the glass tube 17 as the burner 20 applies heat to soften the glass tube 17 and eventually separate the open end portion 18 from the remainder of the glass tube 17 (at the position “A”). Subsequently, the burner 20 applies heat to the upper edge of the separated open end portion 18 to form the bottom portion 21 (at the positions “B” to “E”). It is, of course, also possible that the burner 20 comprises two separate burners, each for performing one of (i) the initial softening and separating of the open end portion 18 from the glass tube 17 and (ii) the formation of the bottom portion 21 (i.e., the same burner 20 does not necessarily perform both the initial softening and separating and the subsequent bottom formation steps “A” to “E”). Thereafter, the formed glass vessel 11 can be left for cooling (at the positions “F” to “H”). At the position “H”, the glass vessel 11 is released from the turntable 13.

As also indicated in the steps shown in FIG. 4, the point burner 16 applies a flame during at least a part of at least one of these formation steps during which the second holding device 15 holds the open end portion 18. In particular, the point burner 16 applies the flame inside the open end portion 18 (i.e., glass vessel 11) during at least a part of at least one of (i) separation of the open end portion 18 from the remainder of the glass tube 17, (ii) formation of the bottom portion 21 on the open end portion 18 to form the glass vessel 11, and/or (iii) a period after the formation of the bottom portion and prior to release of the open end portion 18 (i.e., glass vessel 11) from the second holding device 15.

As a result of the process described above and shown in FIG. 4, no subsequent intermediate fire-blast treatment is necessary after formation of the glass vessel 11 and release of the glass vessel 11 from the second holding device 15. Therefore, the glass vessel 11 can be transported directly to a subsequent processing station after release from the second holding device 15. Such subsequent processing station can be an oven for annealing the glass vessel 11. Consequently, the overall time requirement for producing the glass vessel 11 is made shorter, and the production process becomes more efficient.

The flame applied by the point burner 16 during the fire-blast treatment can be an oxygen-flammable gas flame containing an oxonium ion jetted toward the inner surface of the open end portion. The oxygen-flammable gas flame with the oxonium ion can be mixed gas flame of a flammable gas and oxygen. The alkali components are chipped off by ions and particles contained in the flame from the point burner 16. Therefore, it is preferable that the flame contains more of the ions and particles. It is presumed that such ions and particles are generated as a result of a combustion reaction between the flammable gas such as a low hydrocarbon and oxygen.

The temperature of a portion of the external (outer) surface of the open end portion which outer surface portion is opposite the portion of the inner surface where volatilization of alkali components occurs (a deteriorated region) due to processing is, for example, between 650° C. and 800° C. The temperature of the external (outer) surface of the open end portion can be measured by a thermometer such as a non-contact thermometer. When a measured temperature of the outer surface is within the specific range of 650° C. to 800° C., the fire-blast treatment proceeds with satisfactory results. On the other hand, a measured temperature outside the specific range means that the fire-blast treatment might not be carried out so appropriately. In that case, conditions of the fire-blast treatment (for example, operation conditions of the burner such as a flow rate of the gas, a time period for the fire-blast treatment, etc.) may be changed so that the measured temperature can be within the specific range.

The fire-blast treatment should include a region of the inner surface of the open end portion 18 (or glass vessel 11) which is located at a height of from 8% to 16%, preferably 6% to 18%, and more preferably 5% to 30% of the total length of the open end portion 18 (or glass vessel) based on the external dimension of the open end portion 18. In other words, to effectively reduce the amount of alkali elution, the inner surface of the open end portion 18 located 8% to 16%, preferably 6% to 20%, and more preferably 5% to 30%, of the total length of the preform from the bottom of the open end portion 18 (or glass vessel 11 or the preform) should be fire-blast treated. It is possible to fire-blast treat only the above mentioned region. Alternatively, however, it is possible to fire-blast treat a broader area which includes the above specific region. Fire-blast treatment of the region noted above is preferably used for production of a glass vessel having a thickness between 0.8 mm to 2.0 mm, for example between 0.9 mm and 1.5 mm, and especially between 1.0 mm and 1.2 mm.

Air evacuation by injecting a pressurized gas such as air into the mouth of the glass vessel can also be performed, either before or immediately after the fire-blast treatment. The pressurized gas is then discharged out through a discharge gap between the supply tube and the mouth of the vessel. The pressurized gas can provide support for the bottom portion 21.

After completion of the formation of the bottom portion 21 and release of the glass vessel 11 from the second holding device 15, the glass vessel 11 can be transported to a subsequent processing station. For example, the glass vessel 11 can be transported to an oven for completion of an annealing process to relieve stresses created during the formation process.

Although the above-described process and apparatus are applicable to producing a glass vessel for any use, the process and apparatus are particularly applicable to producing a glass vial for medical use.

1. A method of producing a glass vessel, comprising:
holding a borosilicate glass tube with a first holding device;
holding an open end portion of the borosilicate glass tube with a second holding device such that the second holding device is spaced apart from the first holding device;
applying heat to the borosilicate glass tube by a burner at a location between the first holding device and the second holding device so as to soften the borosilicate glass tube and separate the open end portion from a remainder of the borosilicate glass tube;
applying heat to the separated open end portion to form a bottom portion on the open end portion and thereby form the glass vessel; and
performing fire-blast treatment of an inner surface of the open end portion with a flame from a point burner during at least a part of at least one of (i) said applying heat to the borosilicate glass tube, (ii) said applying heat to the separated open end portion, and (iii) a period after applying heat to the separated open end portion and prior to said releasing the glass vessel from the second holding device.

2. The method of producing the glass vessel according to claim 1, wherein said fire-blast treatment is performed such that a temperature of an outer surface of the open end portion opposite a deteriorated region of the open end portion is between 650° C. and 800° C.

3. The method of producing the glass vessel according to claim 2, wherein the temperature is measured using a non-contact thermometer.

4. The method of producing the glass vessel according to claim 1, wherein said fire-blast treatment comprises jetting an oxygen-flammable gas flame containing an oxonium ion toward the inner surface of the open end portion.

5. The method of producing the glass vessel according to claim 4, wherein the oxygen-flammable gas flame containing the oxonium ion is a mixed gas flame of a flammable gas and oxygen.

6. The method of producing the glass vessel according to claim 1, wherein the glass vessel is a glass vial or ampule for medical use.

7. The method of producing the glass vessel according to claim 1, further comprising performing gas evacuation of the glass vessel prior to or after said fire-blast treatment.

8. The method of producing the glass vessel according to claim 1, upon completion of said applying heat to the separated open end portion to form the glass vessel, releasing the glass vessel from the second holding device is carried out so as to transport the glass vessel to a subsequent processing station, which is an oven in which the glass vessel is annealed.

9. The method of producing the glass vessel according to claim 1, wherein the first holding device is a first chuck, and the second holding device is a second chuck.

10. An apparatus for producing a glass vessel, said apparatus comprising:
a first holding device configured to hold a borosilicate glass tube;
a second holding device configured to hold an open end portion of the borosilicate glass tube, said second holding device being spaced apart from said first holding device;
a burner configured to apply heat to the borosilicate glass tube at a location between said first holding device and said second holding device so as to soften the borosilicate glass tube and separate the open end portion from a remainder of the borosilicate glass tube, and configured to apply heat to the separated open end portion to form a bottom portion on the open end portion and thereby form the glass vessel; and
a point burner configured to perform fire-blast treatment of an inner surface of the open end portion with a flame while said second holding device holds the open end portion and during at least one of (i) application of heat to the borosilicate glass tube by the burner, (ii) application of heat to the separated open end portion to form the glass vessel, and (iii) after applying heat to the separated open end portion and prior to release of the glass vessel by said second holding device.

11. The apparatus for producing the glass vessel according to claim 10, wherein said point burner is configured to perform the fire-blast treatment such that a temperature of an outer surface of the open end portion opposite a deteriorated region of the open end portion is between 650° C. and 800° C.

12. The apparatus for producing the glass vessel according to claim 11, further comprising a non-contact thermometer for measuring the temperature.

13. The apparatus for producing the glass vessel according to claim 10, wherein said point burner is configured to jet an oxygen-flammable gas flame containing an oxonium ion toward the inner surface of the open end portion.

14. The apparatus for producing the glass vessel according to claim 13, wherein the oxygen-flammable gas flame containing the oxonium ion is a mixed gas flame of a flammable gas and oxygen.

15. The apparatus for producing the glass vessel according to claim 10, wherein the glass vessel is a glass vial or ampule for medical use.

16. The apparatus for producing the glass vessel according to claim 10, further comprising a gas evacuation device for performing gas evacuation of the glass vessel prior to or after said fire-blast treatment.

17. The apparatus for producing the glass vessel according to claim 10, further comprising an oven configured to anneal the glass vessel after the glass vessel is released from said second holding device.

18. The apparatus for producing the glass vessel according to claim 10, wherein said first holding device is a first chuck, and said second holding device is a second chuck.
